(19) United States
(12) Patent Application Publication
(10) Pub. No.: US 2026/0238132 A1
(43) Pub. Date: Aug. 13, 2026

(54) POWER CONVERTING DEVICE

(71) Applicant: Lite-On Technology Corporation, Taipei (TW)

(72) Inventors: Kai-De Chen, Taipei (TW); Yong-Long Syu, Taipei (TW); Han-Min Huang, Taipei (TW); Yao Cheng Tien, Taipei (TW); Chen Chen, Taipei (TW)

(73) Assignee: Lite-On Technology Corporation, Taipei (TW)

(21) Appl. No.: 19/246,718

(22) Filed: Jun. 24, 2025

Related U.S. Application Data
(60) Provisional application No. 63/757,340, filed on Feb. 12, 2025.

(30) Foreign Application Priority Data
May 29, 2025 (CN) 202510709894.X

(51) Int. Cl. H02M 3/335

(52) U.S. Cl. CPC H02M 3/3353

(57) ABSTRACT

Provided is a power converting device including a main power stage, an auxiliary power source, and a controller circuit. The main power stage is configured to convert an input voltage to an output voltage. The auxiliary power source is configured to convert the input voltage to at least one power voltage. The controller circuit is coupled to the main power stage and the auxiliary power source. The controller circuit is configured to sample the power supply voltage to obtain a sample voltage. The controller circuit determines a sample input voltage based on the sample voltage.

### CROSS-REFERENCE TO RELATED APPLICATION

This application claims the priority benefit of U.S. provisional application Ser. No. 63/757,340, filed on Feb. 12, 2025, and China application serial no. 202510709894.X, filed on May 29, 2025. The entirety of each of the above-mentioned patent applications is hereby incorporated by reference herein and made a part of this specification.

### BACKGROUND

### Technical Field

The disclosure relates to a signal converting circuit, and particularly relates to a power converting device.

### Related Art

In switched-mode power supplies, related detection signals are needed to complete functions such as voltage regulation, overvoltage protection, and overcurrent protection of the power supply. In switched non-isolated power supplies, the input voltage and output voltage both belong to the same ground level, and thus input and output voltage detection signals may be directly read by the control chip. However, in switched isolated power supplies, since the input voltage and output voltage each belong to different ground levels, switched isolated power supplies need additional components to convert ground levels. However, in the related art, components used for converting ground levels are expensive and occupy large areas.

### SUMMARY

The disclosure provides a power converting device, in which the controller circuit may determine the sample input voltage based on the sample voltage, without needing additional components to convert ground levels.

The power converting device of an embodiment of the disclosure includes a main power stage, an auxiliary power source, and a controller circuit. The main power stage is configured to convert an input voltage to an output voltage. The auxiliary power source is configured to convert the input voltage to at least one power voltage. The controller circuit is coupled to the main power stage and the auxiliary power source. The controller circuit is configured to sample the power supply voltage to obtain a sample voltage. The controller circuit determines a sample input voltage based on the sample voltage.

The power converting device of an embodiment of the disclosure includes a first converter, a second converter, and a controller circuit. The first converter is configured to receive an input voltage and output a first output voltage. The second converter is coupled to the first converter. The second converter is configured to receive the input voltage and output a second output voltage and a third output voltage. The controller circuit is coupled to the first converter and the second converter. The controller circuit is configured to determine a sample input voltage based on the second output voltage and the third output voltage.

To make the foregoing features and advantages of the disclosure more comprehensible, embodiments are specifically provided below and described in detail with the accompanying drawings as follows.

### BRIEF DESCRIPTION OF THE DRAWINGS

FIG. 1 shows a schematic diagram of a power converting device according to an embodiment of the disclosure.

FIG. 2 shows an internal circuit diagram of an auxiliary power source according to an embodiment of the disclosure.

FIG. 3 shows an internal circuit diagram of the auxiliary power source according to another embodiment of the disclosure.

FIG. 4A, FIG. 4B, and FIG. 4C respectively show internal circuit diagrams of different implementations of a main power stage in FIG. 1.

FIG. 5 shows a schematic diagram of the power converting device according to another embodiment of the disclosure.

### DESCRIPTION OF THE EMBODIMENTS

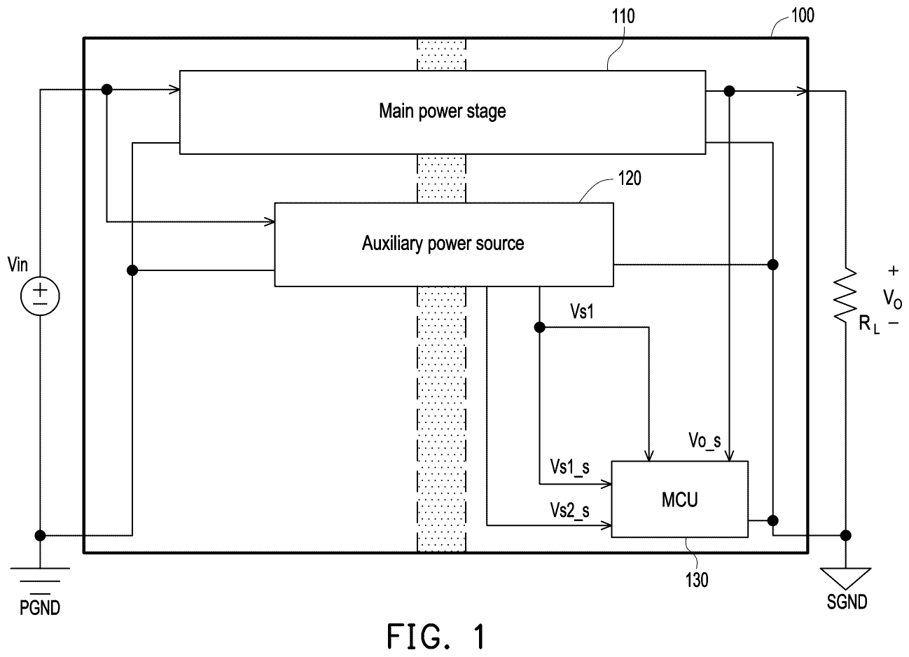

FIG. 1 shows a schematic diagram of a power converting device according to an embodiment of the disclosure. Referring to FIG. 1, a power converting device 100 is configured to convert an input voltage Vin to an output voltage Vo. The power converting device 100 is a switched isolated power source, with a primary side thereof coupled to a first ground level PGND and a secondary side thereof coupled to a second ground level SGND. Therefore, the input voltage Vin and the output voltage Vo have different ground levels PGND and SGND.

The power converting device 100 includes a main power stage 110, an auxiliary power source 120, and a controller circuit 130. The main power stage 110 is configured to convert the input voltage Vin to the output voltage Vo. The auxiliary power source 120 is configured to provide power required for operation of various components within the switched isolated power source. In this example, the auxiliary power source 120 converts the input voltage Vin to a first power voltage Vs1 and outputs to the controller circuit 130. The primary sides of the main power stage 110 and the auxiliary power source 120 are coupled to the first ground level PGND, and the secondary sides of the main power stage 110 and the auxiliary power source 120 are coupled to the second ground level SGND that is different from the first ground level PGND.

The controller circuit 130 is configured to control the operation of the main power stage 110, and samples the input voltage Vin and the output voltage Vo to perform functions such as voltage regulation, overvoltage protection, and overcurrent protection. The controller circuit 130 is, for example, a microcontroller unit (MCU), and regarding a hardware structure thereof, sufficient teaching, suggestions, and implementation instructions may be obtained by referring to the common knowledge in the technical field.

Specifically, in this embodiment, the controller circuit 130 is configured to sample the input voltage Vin and the output voltage Vo. Since the ground level of the controller circuit 130 is SGND, which is the same as the output voltage Vo, the controller circuit 130 may directly sample the output voltage Vo to obtain a sample output voltage Vo_s. On the other hand, the auxiliary power source 120 may output sample voltages Vs1_s and Vs2_s to the controller circuit 130 based on the input voltage Vin. Then, the controller circuit 130 calculates a sample input voltage Vin_s based on the sample voltages Vs1_s and Vs2_s.

Therefore, in this embodiment, the controller circuit 130 may determine the sample input voltage Vin_s based on the sample voltages Vs1_s and Vs2_s, and the power converting device 100 does not need to configure additional isolated voltage sensors, which may effectively reduce component cost and addresses the issue of occupying large areas.

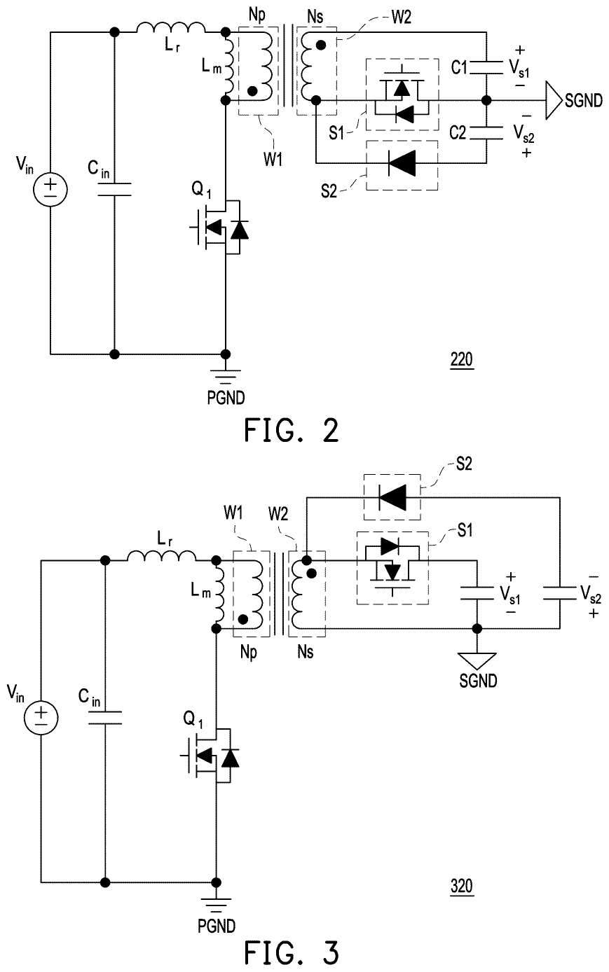

FIG. 2 shows an internal circuit diagram of an auxiliary power source according to an embodiment of the disclosure. Referring to FIG. 2, an auxiliary power source 220 of this embodiment may be a flyback converter, such as a quasi-resonant (QR) flyback converter or an active-clamp flyback converter.

The secondary side of the auxiliary power source 220 includes a first switch S1, a second switch S2, a first capacitor C1, and a second capacitor C2. A first terminal of the first switch S1 is coupled to a second terminal of the secondary coil W2, and a second terminal of the first switch S1 is coupled to a second terminal of the first capacitor C1 and the ground level SGND. A first terminal of the second switch S2 is coupled to the second terminal of the secondary coil W2, and a second terminal of the second switch S2 is coupled to a second terminal of the second capacitor C2. A first terminal of the first capacitor C1 is coupled to a first terminal of the secondary coil W2, and the second terminal of the first capacitor C1 is coupled to the second terminal of the first switch S1 and the ground level SGND. A first terminal of the second capacitor C2 is coupled to the second terminal of the first capacitor C1 and the ground level SGND, and the second terminal of the second capacitor C2 is coupled to the second terminal of the second switch S2.

The first capacitor C1 is configured to provide the first power voltage Vs1, and a voltage value thereof may be determined based on the voltage required for the operation of the controller circuit 130. The second capacitor C2 is configured to provide a second power voltage Vs2, and a voltage value thereof may be determined according to the following formula:

$$Vs 2 = Vin \times \frac{Ns}{Np} + Vs 1$$

In the formula, Np is the number of turns of a primary coil W1, and Ns is the number of turns of a secondary coil W2. Ns/Np is the turns ratio. Therefore, in this example, the auxiliary power source 220 converts the input voltage Vin to the first power voltage Vs1 and the second power voltage Vs2.

The controller circuit 130 respectively samples the power voltages Vs1 and Vs2 having the same ground level SGND to obtain sample voltages Vs1_s and Vs2_s, and the controller circuit 130 then calculates the sample input voltage Vin_s based on the sample voltages Vs1_s and Vs2_s, with the equation thereof as follows:

$$\begin{matrix}Vin\_s = Vs 2 \_s - Vs 1 \_s \\ = Vin \times \frac{Ns}{Np} + Vs 1 - Vs 1 \\ = Vin \times \frac{Ns}{Np}\end{matrix}$$

In the equation, Vs1_s=Vs1, and Vs2_s=Vs2.

From the equation, it may be known that after the controller circuit 130 respectively samples the power voltages Vs1 and Vs2 and subtracts them, the equation of the input voltage Vin multiplied by the turns ratio Ns/Np may be obtained. That is, the sample input voltage Vin_s is proportional to the input voltage Vin. Since the turns ratio Ns/Np is known, the sample input voltage Vin_s may be obtained through calculation by the controller circuit 130, and the power converting device 100 does not need to configure additional isolated voltage sensors.

FIG. 3 shows an internal circuit diagram of an auxiliary power source according to another embodiment of the disclosure. Referring to FIG. 3, an auxiliary power source 320 of this embodiment is similar to the auxiliary power source 220 in FIG. 2, but the main difference between the two components is, for example, in the connection method of the sample lines.

Specifically, a first terminal of the first switch S1 is coupled to a first terminal of the secondary coil W2, and a second terminal of the first switch S1 is coupled to a first terminal of the first capacitor C1. A first terminal of the second switch S2 is coupled to the first terminal of the secondary coil W2, and a second terminal of the second switch S2 is coupled to a first terminal of the second capacitor C2. The first terminal of the first capacitor C1 is coupled to the second terminal of the first switch S1, and a second terminal of the first capacitor C1 is coupled to a second terminal of the secondary coil W2 and the ground level SGND. The first terminal of the second capacitor C2 is coupled to the second terminal of the second switch S2, and a second terminal of the second capacitor C2 is coupled to the second terminal of the secondary coil W2 and the ground level SGND.

The voltage value of the second capacitor C2 may be determined according to the following formula:

$$Vs 2 = - Vin \times \frac{Ns}{Np}$$

The controller circuit 130 may calculate the sample input voltage Vin_s through the equation as follows:

$$\begin{matrix}Vin\_s = - Vs 2 \_s \\ = Vin \times \frac{Ns}{Np}\end{matrix}$$

Therefore, regardless of the connection method of the sample lines, the sample input voltage Vin_s may be obtained through calculation by the controller circuit 130, and the power converting device 100 does not need to configure additional isolated voltage sensors.

In FIG. 2 and FIG. 3, the first switch S1 and the second switch S2 are respectively exemplified by a metal-oxide-semiconductor field-effect transistor (MOSFET) and a diode, but the disclosure is not limited thereto. The first switch S1 and the second switch S2 may also be implemented using other types of switching elements.

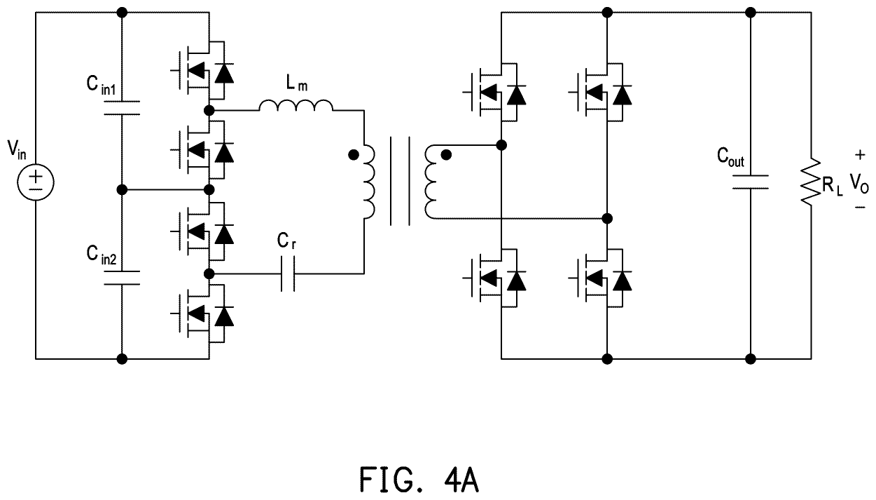

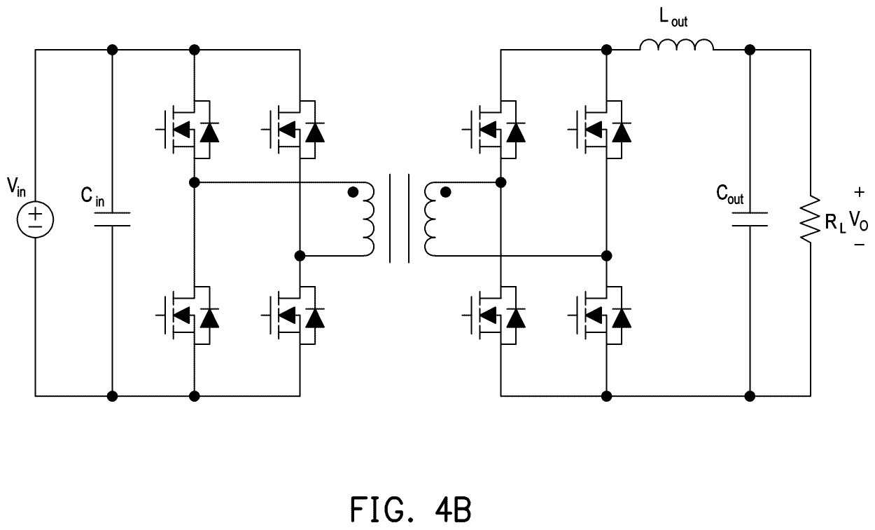

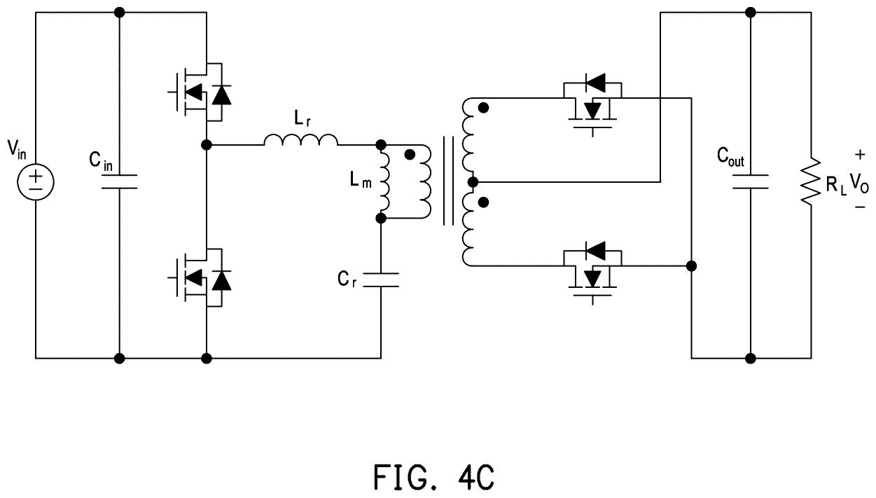

FIG. 4A, FIG. 4B, and FIG. 4C respectively show internal circuit diagrams of different implementations of the main power stage in FIG. 1. Referring to FIG. 4A, FIG. 4B, and FIG. 4C, the main power stage 110 in FIG. 1 may be the multi-stage LLC converter in FIG. 4A, the full-bridge to full-bridge converter in FIG. 4B, or the half-bridge LLC converter in FIG. 4C, but the disclosure is not limited thereto. The main power stage 110 may also be implemented using converters of other different architectures.

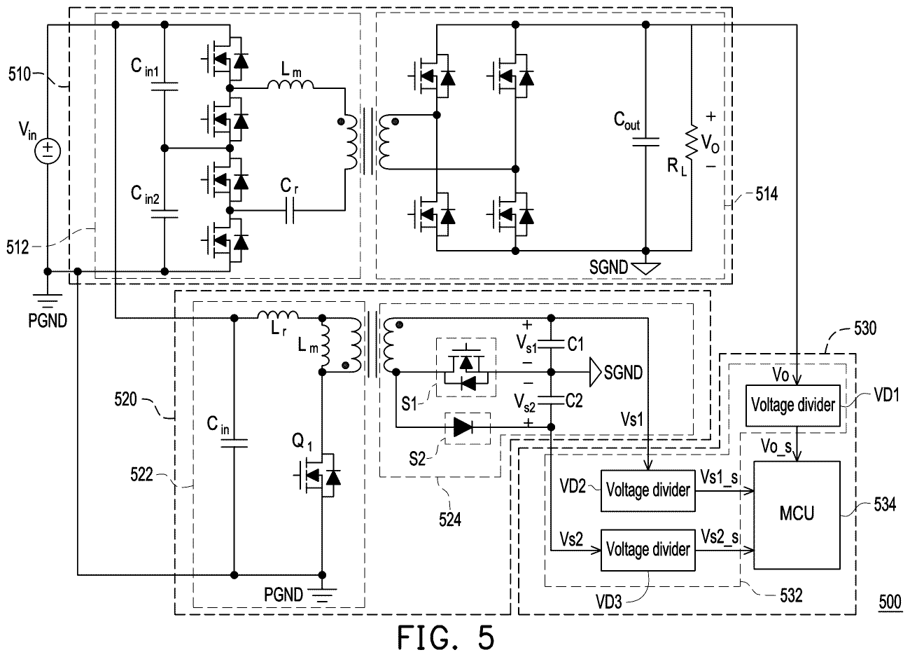

FIG. 5 shows a schematic diagram of the power converting device according to another embodiment of the disclosure. Referring to FIG. 5, a power converting device 500 includes a first converter 510, a second converter 520, and a controller circuit 530. The first converter 510 is configured to receive an input voltage Vin and output a first output voltage Vo. The second converter 520 is coupled to the first converter 510. The second converter 520 is configured to receive the input voltage Vin and output a second output voltage Vs1 and a third output voltage Vs2. The controller circuit 530 is coupled to the first converter 510 and the second converter 520. The controller circuit 530 is configured to determine a sample input voltage Vin_s based on the second output voltage Vs1 and the third output voltage Vs2.

The first converter 510 is, for example, the multi-stage LLC converter in FIG. 4A. The first converter 510 includes a first primary-side circuit 512 and a first secondary-side circuit 514. The first primary-side circuit 512 receives the input voltage Vin. The first secondary-side circuit 514 outputs the first output voltage Vo.

The second converter 520 is, for example, the auxiliary power source 220 in FIG. 2. The second converter 520 includes a second primary-side circuit 522 and a second secondary-side circuit 524. The second primary-side circuit 522 is coupled to the first primary-side circuit 512. The second secondary-side circuit 524 outputs the second output voltage Vs1 and the third output voltage Vs2.

The controller circuit 530 includes a voltage dividing circuit 532 and a controller 534. The voltage dividing circuit 532 is electrically connected to the controller 534 and the first converter 510. In this example, a voltage divider VD1 of the voltage dividing circuit 532 receives the first output voltage Vo from the first converter 510, and outputs the first output voltage Vo_s after division to the controller 534.

On the other hand, the voltage dividing circuit 532 is electrically connected to the second converter 520. In this example, voltage dividers VD2 and VD3 of the voltage dividing circuit 532 respectively receive the second output voltage Vs1 and the third output voltage Vs2 from the second converter 520, and output the second output voltage Vs1_s and the third output voltage Vs2_s after division to the controller 534. Therefore, the controller 534 may determine the sample input voltage Vin_s based on the second output voltage Vs1_s after division and the third output voltage Vs2_s after division, and the determination method thereof may refer to the description of the embodiment of FIG. 2. For example, the sample input voltage Vin_s is equal to a difference between the second output voltage Vs1_s after division and the third output voltage Vs2_s after division, and the sample input voltage Vin_s is proportional to the input voltage Vin.

In this embodiment, the voltage dividing circuit 532 is an optionally disposed circuit. When the voltage values of the first output voltage Vo, the second output voltage Vs1, and the third output voltage Vs2 exceed the rated voltage value that the controller 534 can withstand, the voltage dividing circuit 532 needs to be additionally installed to divide the first output voltage Vo, the second output voltage Vs1, and the third output voltage Vs2 into the first output voltage Vo_s, the second output voltage Vs1_s, and the third output voltage Vs2_s, so that the controller 534 may perform subsequent processing. If the voltage values of the first output voltage Vo, the second output voltage Vs1, and the third output voltage Vs2 are within the range that the controller 534 may normally process, then the voltage dividing circuit 532 is not needed.

In summary, in the embodiments of the disclosure, the controller circuit may sample the power voltage to obtain the sample voltage, and determine the sample input voltage based on the sample voltage. Therefore, even if the input voltage and the output voltage belong to different ground levels, the power converting device does not need additional components to convert ground levels. Through the design of the auxiliary power source sample circuit and the calculation of the controller circuit, the sample input voltage may also be obtained.

Although the disclosure has been disclosed above with embodiments, the embodiments are not intended to limit the disclosure. Persons having ordinary knowledge in the technical field may make some changes and modifications without departing from the spirit and scope of the disclosure. Therefore, the protection scope of the disclosure shall be defined by the appended claims.

What is claimed is:

1. A power converting device, comprising:
a main power stage configured to convert an input voltage to an output voltage;
an auxiliary power source configured to convert the input voltage to at least one power voltage; and
a controller circuit coupled to the main power stage and the auxiliary power source, and configured to sample the at least one power voltage to obtain at least one sample voltage, wherein the controller circuit determines a sample input voltage based on the at least one sample voltage.

2. The power converting device according to claim 1, wherein primary sides of the main power stage and the auxiliary power source are coupled to a first ground level, and secondary sides of the main power stage and the auxiliary power source are coupled to a second ground level different from the first ground level.

3. The power converting device according to claim 1, wherein the at least one power voltage comprises a first power voltage and a second power voltage, and the controller circuit respectively samples the first power voltage and the second power voltage to obtain a first sample voltage and a second sample voltage.

4. The power converting device according to claim 3, wherein the controller circuit calculates a difference between the first sample voltage and the second sample voltage to obtain the sample input voltage.

5. The power converting device according to claim 4, wherein the second power voltage is determined based on the input voltage, a turns ratio of the auxiliary power source, and the first power voltage.

6. The power converting device according to claim 5, wherein the sample input voltage is determined based on the input voltage and the turns ratio of the auxiliary power source.

7. The power converting device according to claim 3, wherein a secondary side of the auxiliary power source comprises:
a first switch having a first terminal and a second terminal, wherein the first terminal of the first switch is coupled to a second terminal of a secondary coil of the auxiliary power source, and the second terminal of the first switch is coupled to a second ground level;
a second switch having a first terminal and a second terminal, wherein the first terminal of the second switch is coupled to the second terminal of the secondary coil;
a first capacitor configured to provide the first power voltage and having a first terminal and a second terminal, wherein the first terminal of the first capacitor is coupled to a first terminal of the secondary coil, and the second terminal of the first capacitor is coupled to the second ground level; and
a second capacitor configured to provide the second power voltage and having a first terminal and a second terminal, wherein the first terminal of the second capacitor is coupled to the second ground level, and the second terminal of the second capacitor is coupled to the second terminal of the second switch.

8. The power converting device according to claim 1, wherein the at least one power voltage comprises a first power voltage and a second power voltage, and the second power voltage is determined based on the input voltage and a turns ratio of the auxiliary power source.

9. The power converting device according to claim 8, wherein the sample input voltage is determined based on the input voltage and the turns ratio of the auxiliary power source.

10. The power converting device according to claim 8, wherein a secondary side of the auxiliary power source comprises:
a first switch having a first terminal and a second terminal, wherein the first terminal of the first switch is coupled to a first terminal of a secondary coil of the auxiliary power source;
a second switch having a first terminal and a second terminal, wherein the first terminal of the second switch is coupled to the first terminal of the secondary coil;
a first capacitor configured to provide the first power voltage and having a first terminal and a second terminal, wherein the first terminal of the first capacitor is coupled to the second terminal of the first switch, and the second terminal of the first capacitor is coupled to a second ground level; and
a second capacitor configured to provide the second power voltage and having a first terminal and a second terminal, wherein the first terminal of the second capacitor is coupled to the second terminal of the second switch, and the second terminal of the second capacitor is coupled to the second ground level.

11. A power converting device, comprising:
a first converter configured to receive an input voltage and output a first output voltage;
a second converter coupled to the first converter and configured to receive the input voltage and output a second output voltage and a third output voltage; and
a controller circuit coupled to the first converter and the second converter, wherein the controller circuit is configured to determine a sample input voltage based on the second output voltage and the third output voltage.

12. The power converting device according to claim 11, wherein
the first converter comprises a first primary-side circuit and a first secondary-side circuit, the first primary-side circuit receives the input voltage, and the first secondary-side circuit outputs the first output voltage, and
the second converter comprises a second primary-side circuit and a second secondary-side circuit, the second primary-side circuit is coupled to the first primary-side circuit, and the second secondary-side circuit outputs the second output voltage and the third output voltage.

13. The power converting device according to claim 11, wherein the sample input voltage is equal to a difference between the second output voltage and the third output voltage.

14. The power converting device according to claim 11, wherein the sample input voltage is proportional to the input voltage.

15. The power converting device according to claim 11, wherein the controller circuit comprises a voltage dividing circuit and a controller, the voltage dividing circuit is electrically connected to the first converter or the second converter, and the voltage dividing circuit is electrically connected to the controller.
